(19) United States
(12) Patent Application Publication
(10) Pub. No.: US 2007/0294052 A1
(43) Pub. Date: Dec. 20, 2007

(54) Supplier teardown & analysis reporting system

(75) Inventors: George L. Stathis, Hamden, CT (US); Cu V. Tran, Milford, CT (US)

Correspondence Address: CARLSON, GASKEY & OLDS, P.C., 400 WEST MAPLE ROAD, SUITE 350, BIRMINGHAM, MI, 48009, US

(73) Assignee: Sikorsky Aircraft Corporation

(21) Appl. No.: 11/454,466

(22) Filed: Jun. 16, 2006

(51) Int. Cl. G06F 19/00; G06F 17/40

(52) U.S. Cl. 702/185; 702/1; 702/34; 702/183; 702/184; 702/187; 702/189

(57) ABSTRACT

A Supplier Teardown and Analysis Reporting System (STARS) captures information pertaining to component removals or failures that caused an unscheduled maintenance action. The detailed data facilitates design engineers understanding of failure drivers and propose improvements and commence implementation of a Corrective Action Plan at the earliest practicable time.

This invention was made with government support under Contract No.: N00383-04-D-028N with the United States Navy. The government therefore has certain rights in this invention.

### BACKGROUND OF THE INVENTION

The present invention relates to an integrated system and method for tracking component repairs, and more particularly to a system and method used to document the reported discrepancy, failure analysis, root cause and proposed corrective action(s) for nonconforming components.

Currently, information pertaining to a component or system removal or failure that caused an unscheduled maintenance event may or may not be retained by the repair facility. However, even if retained at the repair facility, the information is not transmitted back to the OEM or customer who first sent the component or system out for repair. That is, the OEM or customer who sent out the defective component or system will receive a repaired or replacement component or system without a detailed description of the failure or repair that was performed at the repair facility.

Although effective, the lack of a detailed description of the failure or repair that was performed at the repair facility prevents an OEM or customer from centralizing the reliability performance database, trending the information to identify potential fleet impact or from utilizing the data as a basis to explore potential continued improvements.

Accordingly, it is desirable to provide an integrated system and a method for tracking component repairs which facilitates failure analysis for determination of root cause and proposed corrective action(s).

### SUMMARY OF THE INVENTION

The integrated tracking system according to the present invention provides a Supplier Teardown and Analysis Reporting System (STARS) which captures information pertaining to component removals or failures that caused an unscheduled maintenance action. The detailed data facilitates design engineer understanding of the failure drivers to propose improvements and commence implementation of a Corrective Action Plan at the earliest practicable time.

The present invention therefore provides an integrated system and a method for tracking component repairs which facilitates failure analysis for determination of root cause and proposed corrective action(s).

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a schematic block diagram of a supplier teardown and analysis reporting system;

FIG. 2 is a screen shot from the supplier teardown and analysis reporting system utilizing a spindle assembly as an example component repair;

FIG. 3A is a perspective view of the spindle assembly described in the screen shot illustrated in FIG. 2;

FIG. 3B is an exploded view of a root cause description of the example spindle assembly; and

FIG. 4 is an example of a supplier teardown and analysis report generated from the supplier teardown and analysis reporting system as would be generated from the information input at FIG. 2.

### DETAILED DESCRIPTION OF THE PREFERRED EMBODIMENT

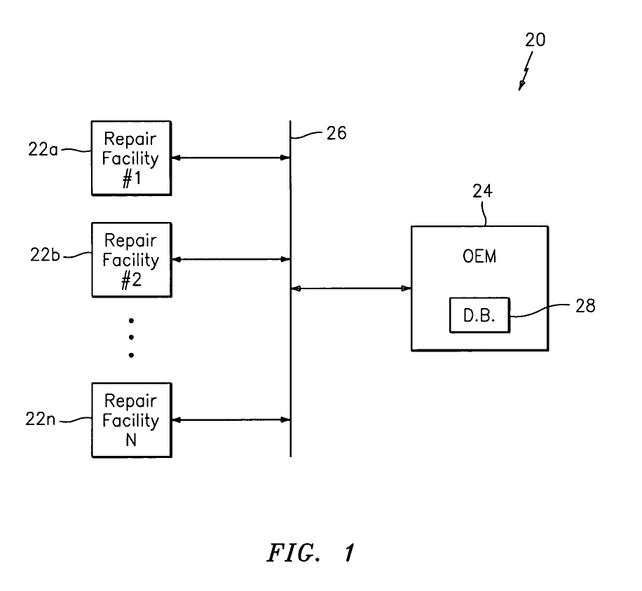

FIG. 1 illustrates an integrated tracking system 20 for tracking repaired components or systems in a block diagram format. The system 20 interconnects any number of repair facility FTP sites 22a-22n with an aircraft OEM file server 24 through a communication system 26 such as the Internet, email, or any suitable transfer or downloading technique known in the art. Each repair facility is typically a remote location such as various repair facility sites, supplier sites, and company business unit sites. It should be understood that repair facility as utilized herein may include any facility which receives components or systems from the OEM or the fleet. That is, a typical “black box” component or system is typically removed from the aircraft and returned to the OEM or designated repair facility. Once repaired, the component or system was heretofore returned to the original operator for immediate use or entry into maintenance stores for later use.

The aircraft OEM filer server 24 includes a centralized component repair information database 28. The centralized component repair information database 28 is referred to herein as a Supplier Teardown and Analysis Reporting System (STARS).

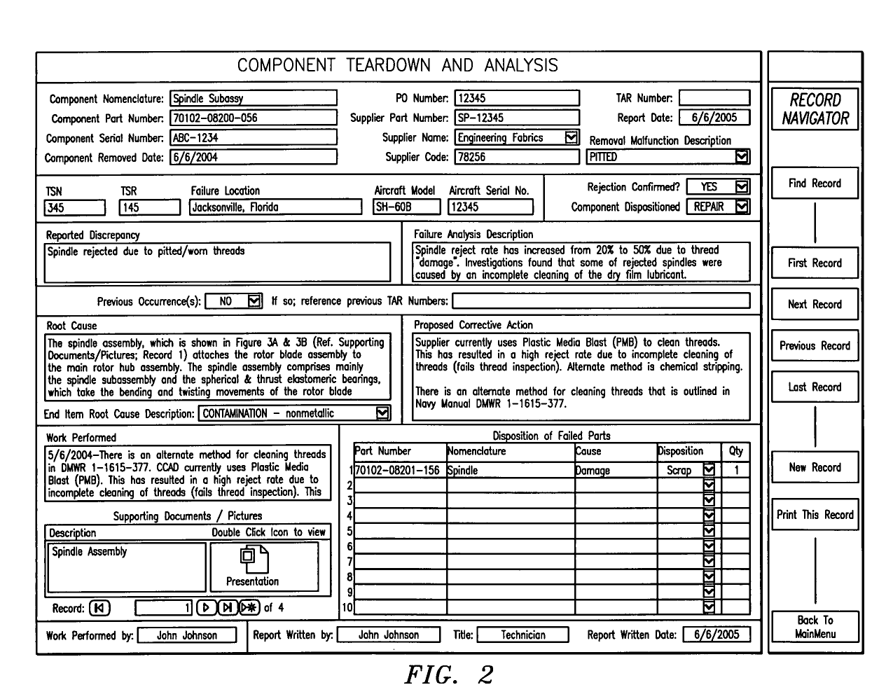

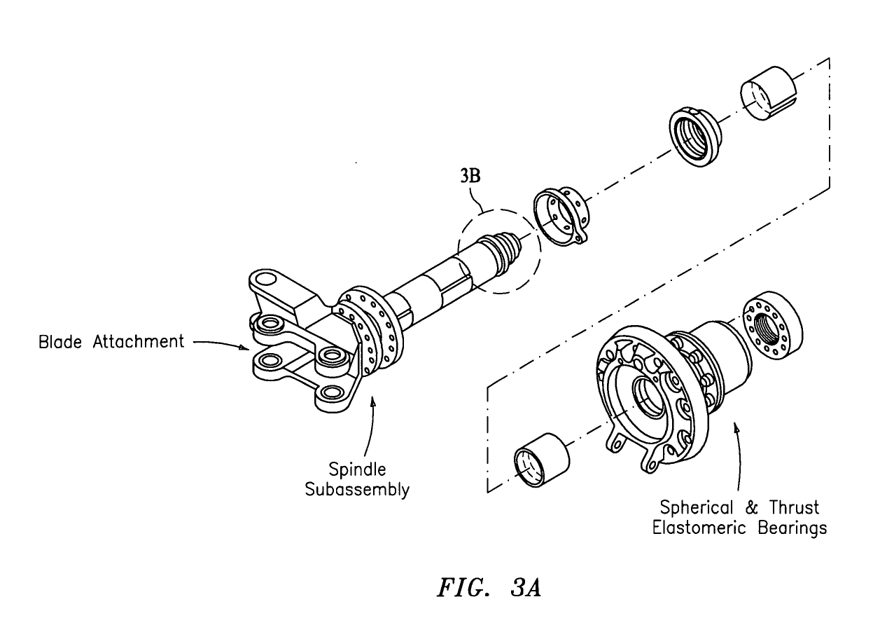

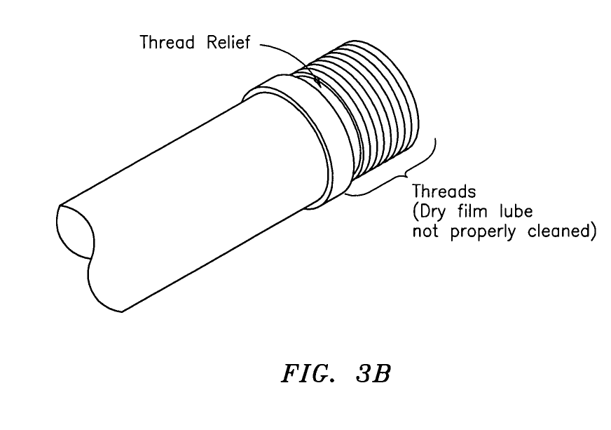

Information about repaired components or systems is entered at the repair facility FTP sites 22a-22n. Data within the repair facility FTP sites 22a-22n about the repaired components or systems is communicated from each of the aforementioned locations to the aircraft OEM 24. It should be understood that various server systems will also be usable with the present invention and that the illustrated embodiment of server systems are for descriptive purposed only. The data typically includes information pertaining to component removals or failures that caused an unscheduled maintenance as well as other information as disclosed in the screen shot (FIG. 2) of the illustrated embodiment which utilizes a spindle assembly (FIGS. 3A and 3B) as an example component which has been sent out to a repair facility. The database 28 may be programmed in any suitable computer language such as Microsoft Access or the like generally known in the art to carry out the herein described functionality.

Referring to FIG. 2, the data entry screen allows the repair facility to enter or update data in the system and to navigate through database records via the action command buttons located on the right of the screen. Most of the data fields are self-explanatory. The description and data type for each field are provided in the Appendix. Some data fields have a drop-down feature for quicker and easier data entry. Drop-down lists also help to ensure that the data that is entered in a field is consistent.

The data entry screen is preferably divided into the following sections:

Upper Section (Failed Component Information)

This section of the screen contains general information about the specific failed component that is returned to supplier for teardown and/or failure evaluation. It is preferably a mandatory requirement to create a new record for each returned component. When a new record is added to the system to document activities performed on a particular failed component, a record number will be assigned to the TAR Number data field. Data type for the TAR Number is an AutoNumber field that automatically enters a number when a record is added. Preferably, once a record number is generated, it can't be deleted or changed.

The repair facility is encouraged to record information from paper documentations that are returned along with the failed component. Field information such as: TSN (Time Since New), TSR (Time Since Repair), and Removal Malfunction etc. can be very useful during the component investigation.

Middle Section (Root Cause Analysis and Corrective Action)

The primary purpose of the STARS 20 is to capture information pertaining to component removals or failures that caused an unscheduled maintenance action. Therefore, detailed data information provided in this section facilitates design engineer understanding of the failure drivers to propose improvements and commence implementation of a Corrective Action Plan at the earliest practicable time. Definitions for some of data fields in this section are as follow:

Failure Analysis Description: Description of how the root cause of the reported problem was determined. The repair facility shall perform a failure analysis on all: (i) in-house or reported failures; and (ii) reported unscheduled maintenance actions when either a failure trend is established (“Failure Trend”) or flight safety is involved (collectively or individual “Failure”). A Failure Trent shall be defined as the establishment of two or more occurrences of the identical unscheduled maintenance event/failure symptom.

Root Cause: Identify the root cause of the failure with substantiating data such as photos, drawings, op-sheets, test and met-lab reports, inspection results and measurements, and analyses which identify the root cause and link it to the Reported Discrepancy.

Proposed Corrective Action: Identify the corrective action that specifically addresses the identified root cause. Substantiate that the corrective action is cost effective in addressing the cause. (E.g. A special inspection may address symptoms and identify that a problem has occurred, but may not be cost effectively in preventing the root cause from reoccurring).

Left Bottom Section (Supporting Documents/Pictures)

This section of the screen permits photos, documents, presentations and the like that support the failure analysis, root cause and corrective action entries.

Right Bottom Section (Disposition of Failed Components)

This section contains detail piece components or sub-assemblies that may contribute to the reported failure. For example only, an electronic system that has several Circuit Card Assemblies (CCAs) may be removed from an aircraft due to a reported “Internal Failure.” During the subsequent teardown/testing process at the repair facility, some CCAs were found inoperable due to corrosion, fatigue, shorts, etc. The repair facility should enter information about individual CCAs in this section.

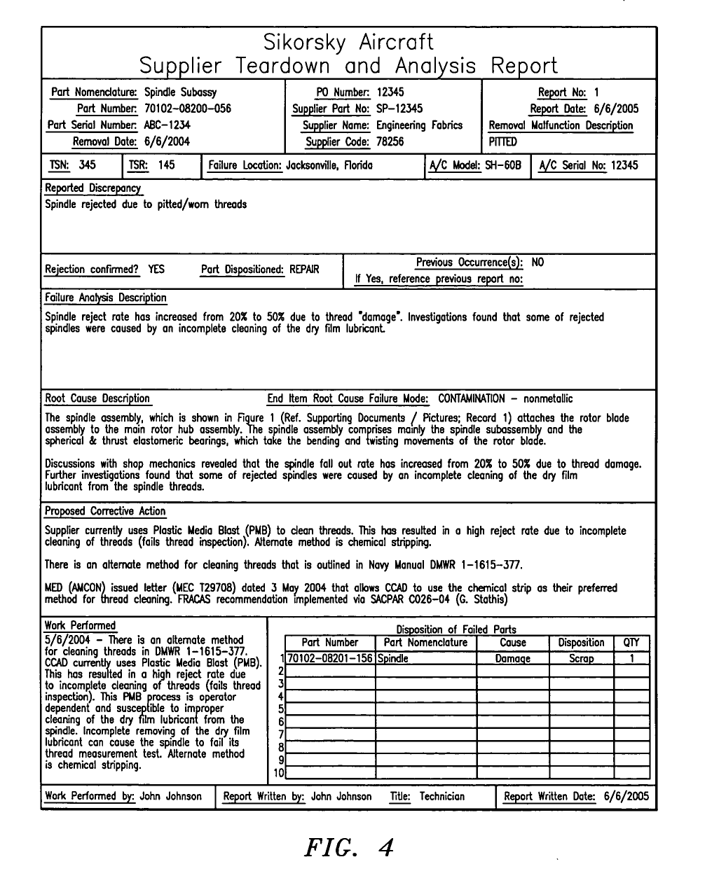

Once data is input into STARS, suppliers may email the MS Access data Table File (“SupplierTAR_be.mdb”) and any supporting information contained in the STARS application folder (“DocumentsPictures”) to an email address of the OEM. The inputted data may also be printed as a report (FIG. 4) for attachment with the returned repaired components and systems or for other recordation usage.

APPENDIX

| Field Name | Data Type | Field Description |
|---|---|---|
| TAR_Number | AutoNumber | Sequential number automatically generated by system when a |
| | | new record is entered |
| Component_Nomenclature | Text | Assembly Name |
| Component_Component_Number | Text | Sikorsky assembly component number |
| Component_Serial_Number | Text | Sikorsky assembly serial number |
| Removal_Date | Date/Time | Date assembly is removed from aircraft |
| Failure_Location | Text | Location where aircraft is operated and assembly is removed |
| | | from that aircraft |
| TSN | Number | Assembly operating Time Since New (Hours) |
| TSR | Number | Assembly Operating Time Since Repair (Hours) |
| Report_Date | Date/Time | Date, the TAR Number is generated |
| Rejection_Confirmed | Text | Indicating whether reported failure is verified (Y/N) |
| Component_Disposition | Text | Indicating whether returned component is scraped or repaired |
| PO_Number | Number | Purchase Order Number |
| Supplier_Name | Text | Supplier Company Name |
| Supplier_Component_Number | Text | Supplier Component Number If different |
| Supplier_Code | Text | Supplier Code |
| Reported_Malfunction_Description | Text | Malfunction assigned to component which was removed from |
| | | aircraft |
| Reported_Discrepancy | Memo | Description of why component is removed |
| Previous_Occurences | Text | Indicating whether this type of failure mode has occurred |
| Reference_Previous_Reports | Text | Provide TAR Number(s) with same failure mode |
| Aircraft_Model | Text | Aircraft Model; SH-60B; SH-60F, MH-60R etc. |
| Aircraft_Serial_Number | Number | Aircraft tail number |
| Failure_Analysis | Memo | Description of how the root cause of the reported problem |
| | | was determined |
| Failure_Root_Cause | Memo | Fundamental breakdown and/or failure which caused the |
| | | reported unscheduled maintenance removal |
| Corrective_Action | Memo | Describe corrective actions implemented to correct the root |
| | | cause identified |
| Work_Performed | Memo | Provide all steps that component is undergone from incoming |
| | | testing to completion of repair |
| Work_Performed_By | Text | Name of shop personnel who repaired component |
| Report_Written_By | Text | Name of personnel who complete root cause and corrective |
| | | action writing |
| TAR_Written_Title | Text | Title of personnel who complete root cause and corrective |
| | | action writing |
| Report_Written_Date | Date/Time | Date, the failure analysis and report is complete |
| End_Item_Root_Cause_Description | Text | Provide short description of failure cause |
| Detailed_Component_1 | Text | Component Number of detailed component |
| Detailed_Component_1_Nomenclature | Text | Name of detailed component |
| Detailed_Component_1_Cause | Text | What cause detailed component to fail |
| Detailed_Component_1_Disp | Text | Detailed component disposition; scrap or repair |
| Detailed_Component_1_Quantity | Number | Provide Quantity |
| Detailed_Component_2 | Text | Component Number of detailed component |
| Detailed_Component_2_Nomenclature | Text | Name of detailed component |
| Detailed_Component_2_Cause | Text | What cause detailed component to fail |
| Detailed_Component_2_Disp | Text | Detailed component disposition; scrap or repair |
| Detailed_Component_2_Quantity | Number | Provide Quantity |
| Detailed_Component_3 | Text | Component Number of detailed component |
| Detailed_Component_3_Nomenclature | Text | Name of detailed component |
| Detailed_Component_3_Cause | Text | What cause detailed component to fail |
| Detailed_Component_3_Disp | Text | Detailed component disposition; scrap or repair |
| Detailed_Component_3_Quantity | Number | Provide Quantity |
| Detailed_Component_4 | Text | Component Number of detailed component |
| Detailed_Component_4_Nomenclature | Text | Name of detailed component |
| Detailed_Component_4_Cause | Text | What cause detailed component to fail |
| Detailed_Component_4_Disp | Text | Detailed component disposition; scrap or repair |
| Detailed_Component_4_Quantity | Number | Provide Quantity |
| Detailed_Component_5 | Text | Component Number of detailed component |
| Detailed_Component_5_Nomenclature | Text | Name of detailed component |
| Detailed_Component_5_Cause | Text | What cause detailed component to fail |
| Detailed_Component_5_Disp | Text | Detailed component disposition; scrap or repair |
| Detailed_Component_5_Quantity | Number | Provide Quantity |
| Detailed_Component_6 | Text | Component Number of detailed component |
| Detailed_Component_6_Nomenclature | Text | Name of detailed component |
| Detailed_Component_6_Cause | Text | What cause detailed component to fail |
| Detailed_Component_6_Disp | Text | Detailed component disposition; scrap or repair |
| Detailed_Component_6_Quantity | Number | Provide Quantity |
| Detailed_Component_7 | Text | Component Number of detailed component |
| Detailed_Component_7_Nomenclature | Text | Name of detailed component |
| Detailed_Component_7_Cause | Text | What cause detailed component to fail |
| Detailed_Component_7_Disp | Text | Detailed component disposition; scrap or repair |
| Detailed_Component_7_Quantity | Number | Provide Quantity |
| Detailed_Component_8 | Text | Component Number of detailed component |
| Detailed_Component_8_Nomenclature | Text | Name of detailed component |
| Detailed_Component_8_Cause | Text | What cause detailed component to fail |
| Detailed_Component_8_Disp | Text | Detailed component disposition; scrap or repair |
| Detailed_Component_8_Quantity | Number | Provide Quantity |
| Detailed_Component_9 | Text | Component Number of detailed component |
| Detailed_Component_9_Nomenclature | Text | Name of detailed component |
| Detailed_Component_9_Cause | Text | What cause detailed component to fail |
| Detailed_Component_9_Disp | Text | Detailed component disposition; scrap or repair |
| Detailed_Component_9_Quantity | Number | Provide Quantity |
| Detailed_Component_10 | Text | Component Number of detailed component |
| Detailed_Component_10_Nomenclature | Text | Name of detailed component |
| Detailed_Component_10_Cause | Text | What cause detailed component to fail |
| Detailed_Component_10_Disp | Text | Detailed component disposition; scrap or repair |
| Detailed_Component_10_Quantity | Number | Provide Quantity |

| Data fields for | | |
|---|---|---|
| Photo/Document | | |
| Table | Data Type | Field Description |
| DOCID | AutoNumber | Sequential number automatically |
| | | generated by system when a new record |
| | | is entered |
| TASKID | Number | Number that links to TAR Number |
| Description | Text | Description of photo/document |
| Document | OLE Object | Photo/document to be inserted |
| Date entered | Date/Time | Date, the photo/document is inserted |

The repair facility shall perform a failure analysis on all: (i) in-house or reported failures; and (ii) reported unscheduled maintenance actions when either a failure trend is established (“Failure Trend”) or flight safety is involved (collectively or individual “Failure”). A Failure Trend shall be defined as the establishment of two or more occurrences of the identical unscheduled maintenance event/failure symptom.

Although particular step sequences are shown, described, and claimed, it should be understood that steps may be performed in any order, separated or combined unless otherwise indicated and will still benefit from the present invention.

The foregoing description is exemplary rather than defined by the limitations within. Many modifications and variations of the present invention are possible in light of the above teachings. The preferred embodiments of this invention have been disclosed, however, one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A method of tracking repaired components comprising the steps of:
(A) inputting data pertaining to unscheduled maintenance of a repaired component by a repair facility user;
(B) communicating data from said step (A) to an OEM; and
(C) compiling the data from said step (B) to facilitate failure analysis tracking of a multiple of the repaired components.

2. A method as recited in claim 1, further comprises the step of:
(D) determination a root cause from said step (C).

3. A method as recited in claim 2, further comprises the step of:
(E) determination a proposed corrective action from said step (D).

4. A method as recited in claim 1, wherein said step (A) further comprises the steps of:
(a) inputting a failure analysis description of the repaired component.

5. A method as recited in claim 1, wherein said step (A) further comprises the steps of:
(a) inputting a root cause of a failure of the repaired component.

6. A method as recited in claim 5, wherein said step (A) further comprises the steps of:
(b) inputting substantiating data for the root cause.

7. A method as recited in claim 6, wherein said step (A) further comprises the steps of:
(c) inputting a proposed corrective action.

8. A method as recited in claim 7, wherein said step (c) further comprises the step of:
(i) inputting substantiating data for the proposed corrective action to demonstrate that the proposed corrective action is cost effective.

9. A method as recited in claim 1, further comprises the step of:
(D) inputting data regarding related components that may contribute to the unscheduled maintenance.

10. A method of tracking repaired components comprising the steps of:
(A) inputting data pertaining to a failure analysis from an unscheduled maintenance of a repaired component by a repair facility user;
(B) inputting data pertaining to a root cause of the unscheduled maintenance of the repaired component by the repair facility user;
(C) inputting data pertaining to a proposed corrective action for the root cause of said step (B) by the repair facility user;
(D) communicating data from said steps (A-C) to an OEM; and
(E) compiling the data at the OEM to facilitate failure analysis tracking of a multitude of the repaired components.

11. A method as recited in claim 10, wherein said step (A) further comprises the steps of:
(a) inputting substantiating data for the failure analysis.

12. A method as recited in claim 10, wherein said step (B) further comprises the steps of:
(a) inputting substantiating data for the root cause.

13. A method as recited in claim 10, wherein said step (C) further comprises the steps of:
(a) inputting substantiating data for the proposed corrective action to demonstrate that the proposed corrective action is cost effective.

14. A method of tracking repaired components comprising the steps of:
(A) receiving data pertaining to a failure analysis from an unscheduled maintenance of a repaired component;
(B) receiving data pertaining to a root cause of the unscheduled maintenance of the repaired component;
(C) receiving data pertaining to a proposed corrective action for the root cause of said step (B); and
(D) compiling the data from said steps (A-C) to facilitate failure analysis tracking of a multitude of the repaired components.

15. A method as recited in claim 1, further comprising the step of:
(E) determination a Corrective Action Plan in response to said step (D).
